(19) United States
(12) Patent Application Publication
(10) Pub. No.: US 2016/0121899 A1
(43) Pub. Date: May 5, 2016

(54) SYSTEM WITH SLIPPABLE TORQUE-TRANSMISSION DEVICE CONNECTING ENGINE CRANKSHAFT AND ENGINE-DRIVEN COMPONENT AND VEHICLE

(71) Applicant: GM GLOBAL TECHNOLOGY OPERATIONS LLC, Detroit, MI (US)

(72) Inventor: Mukund S. Wankhede, Fort Gratiot, MI (US)

(21) Appl. No.: 14/527,018

(22) Filed: Oct. 29, 2014

(51) Int. Cl. B60W 30/188; F16H 7/08; B60K 17/28; B60W 10/06; B60W 10/30; F16H 63/44; B60W 10/02

(52) U.S. Cl. CPC B60W 30/1886; F16H 63/44; F16H 7/08; B60W 10/02; B60W 10/06; B60W 10/30; B60K 17/28; F16H 2007/0885; B60W 2510/0638; B60W 2710/025; B60W 2710/30; B60W 2400/00; B60W 2710/021

(57) ABSTRACT

A system for a vehicle includes an engine having a rotatable crankshaft and an engine-driven component having a rotatable component shaft. A torque-transmission device has a drive element operatively connected to the crankshaft and a driven element operatively connected to the rotatable component shaft. The torque-transmission device has a slipping state in which slip occurs during torque transfer from the drive element to the driven element so that a speed differential exists between the drive element and the driven element. An electronic controller is operatively connected to the crankshaft, the rotatable component shaft, and the torque-transmission device. The electronic controller includes a processor with a stored algorithm executed to establish the slipping state to maintain a rotational speed of the rotatable component shaft at or below a predetermined rotational speed.

### TECHNICAL FIELD

The present teachings generally include a vehicle system with a slippable torque-transmission device connecting an engine crankshaft and a compressor.

### BACKGROUND

Automotive vehicles that have an air conditioning system may have an air-conditioning compressor that is driven by the rotating engine crankshaft. The compressor is typically rated for a maximum rotational speed. The system is thus designed to disconnect the compressor from the engine crankshaft when the rotational speed of the crankshaft would otherwise cause the rotational speed of the compressor to exceed the rated maximum rotational speed. Air conditioning is thus not available at high rotational speeds of the engine.

### SUMMARY

A system is provided that protects engine-driven vehicle components from excessive rotational speed while still allowing their full functionality during periods of relatively high engine crankshaft speed. Specifically, a system for a vehicle is provided that includes an engine having a rotatable crankshaft and an engine-driven component having a rotatable component shaft. A torque-transmission device has a drive element operatively connected to the crankshaft and a driven element operatively connected to the rotatable component shaft. The torque-transmission device has a slipping state in which torque transfer from the drive element to the driven element so that a speed differential exists between the drive element and the driven element. An electronic controller is operatively connected to the crankshaft, the rotatable component shaft, and the torque-transmission device. The electronic controller includes a processor with a stored algorithm. The processor executes the stored algorithm to establish the slipping state to maintain a rotational speed of the rotatable component shaft at or below a predetermined rotational speed. In one embodiment, the engine-driven component is an air-conditioning compressor, such as a fixed displacement, variable displacement or scroll compressor, and the rotatable component shaft is a compressor shaft.

In one aspect of the present teachings, one or more speed sensors provide speed signals indicative of a rotational speed of the crankshaft and/or of the rotatable component shaft. The speed signal(s) can be used to enable the electronic controller to determine the rotational speed of the rotatable component shaft, and thereby determine whether the slipping state should be established. Alternatively, a separate engine controller can provide a signal indicative of engine speed to the electronic controller, and a separate HVAC controller can provide a signal to the electronic controller indicative of the rotational speed of the engine-driven component. These signals may be based on speed sensors or on other monitored vehicle operating conditions.

The system may include a gear train, or one or more drive trains having an endless rotatable device, such as belt drive trains. This permits more than one engine-driven component. The electronic controller may control the torque-transmission device to establish the slipping state to maintain a rotational speed of a first rotatable component shaft of the first rotatable component at or below a first predetermined rotational speed, and to maintain a rotational speed of a second rotatable component shaft of a second rotatable component at or below a second predetermined rotational speed. In this manner, neither of the engine-driven components exceed their respective predetermined maximum rotational speed (i.e., their rated maximum rotational speed).

The electronic controller may be configured to increase the torque provided by the engine at the crankshaft when controlling the torque-transmission device to transition from a disengaged state to an engaged state. By increasing the torque provided by the engine, the extra load of the engine-driven component borne by the engine upon engagement of the torque-transmission device does not diminish driveline torque in the vehicle.

Various embodiments of the torque-transmission component may be used, such as but not limited to a friction plate clutch, a magnetorheological clutch, or an electromagnetic clutch.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic illustration of a first embodiment of a system on a vehicle having a slippable torque-transmission device operatively connecting an engine crankshaft and a compressor shaft in accordance with an aspect of the present teachings.

FIG. 2 is a schematic illustration of a second embodiment of a system on a vehicle having a slippable torque-transmission device operatively connecting an engine crankshaft and a compressor shaft in accordance with an alternative aspect of the present teachings.

FIG. 3 is a schematic illustration of a third embodiment of a system on a vehicle having a slippable torque-transmission device operatively connecting an engine crankshaft and a compressor shaft in accordance with another alternative aspect of the present teachings.

FIG. 4 is a schematic illustration of a fourth embodiment of a system on a vehicle having a slippable torque-transmission device operatively connecting an engine crankshaft and a compressor shaft in accordance with another alternative aspect of the present teachings.

FIG. 5 is a schematic cross-sectional view of a first embodiment of a slippable torque-transmission device for the systems of FIGS. 1-4 in accordance with an aspect of the present teachings.

FIG. 6 is a schematic cross-sectional view of a second embodiment of a slippable torque-transmission device for the systems of FIGS. 1-4 in accordance with an alternative aspect of the present teachings.

FIG. 7 is a schematic cross-sectional view of a third embodiment of a slippable torque-transmission device for the systems of FIGS. 1-4 in accordance with another alternative aspect of the present teachings.

### DETAILED DESCRIPTION

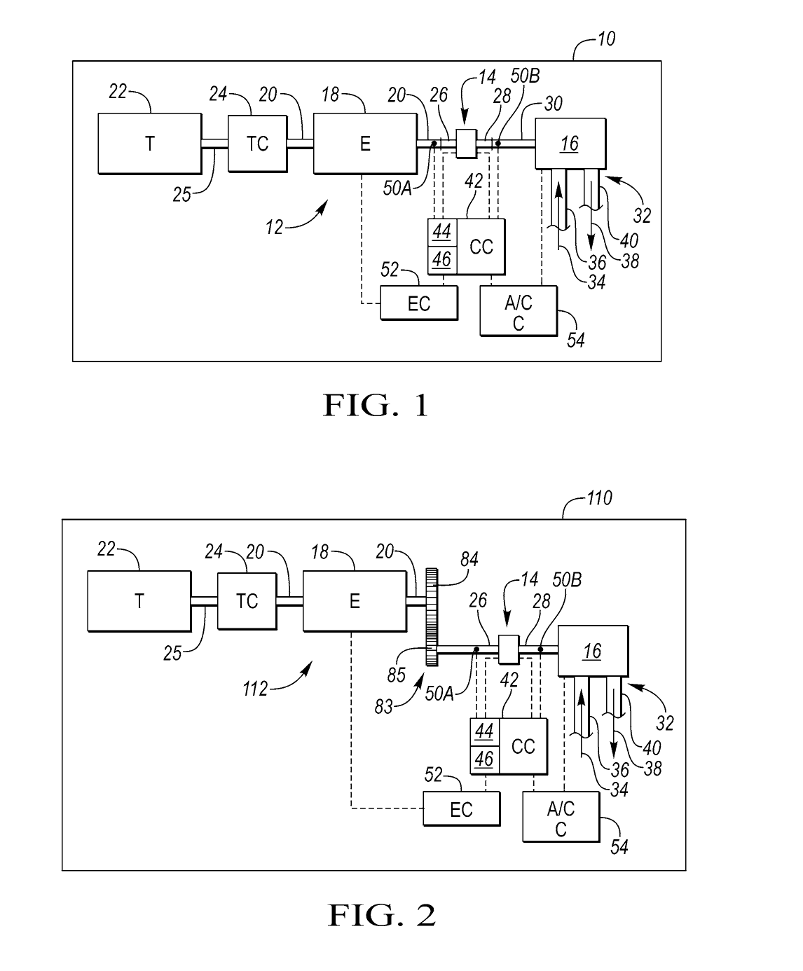

Referring to the drawings, wherein like reference numbers refer to like components, FIG. 1 shows a vehicle 10 that has a system 12 that controls a torque-transmission device (TTD) 14 to slip to prevent a first engine-driven component 16 from exceeding a predetermined rotational speed, which may be a maximum rated rotational speed and is also referred to herein as a predetermined maximum rotational speed. This avoids the alternative of disconnecting the engine-driven component 16 from the engine when the engine 18 (labelled E) causes the rotational speed higher than the predetermined maximum rotational speed, thereby enabling functionality of the engine-driven component 16 over the entire range of engine speeds.

The engine 18 has a rotatable crankshaft 20. One end of the crankshaft 20 drives a transmission 22 (labelled T) through a torque converter 24 (labelled TC) connected to an input shaft 25 of the transmission 22. The transmission 22 is connected to one or more drive axles (not shown) to propel the vehicle 10, as is understood by those skilled in the art. The other end of the crankshaft 20 is operatively connected to a drive element 26 of the TTD 14 to rotate in unison therewith. As used herein, two components “rotate in unison” when they are connected to rotate at a common speed (i.e., at the same rotational speed).

In addition to the drive element 26, the torque-transmission device 14 has a driven element 28 operatively connected to a rotatable component shaft 30 of the engine-driven component 16. In the embodiment shown, the engine-driven component 16 is an air conditioning compressor of a climate control system 32, such as a heating-ventilation-air conditioning (HVAC) system. Accordingly, the engine-driven component 16 is also referred to herein as a compressor, and the rotatable component shaft 30 is also referred to herein as a compressor shaft. In other embodiments within the scope of the present teachings, the engine-driven component 16 can be another component, such as an alternator or a water pump. Relatively low pressure refrigerant represented by arrow 34 enters the compressor 16 through a low pressure conduit 36, and relatively high pressure refrigerant represented by arrow 38 exits the compressor 16 through a high pressure conduit 40.

The compressor 16 may have a maximum rated rotational speed in revolutions per minute during operation of the vehicle 10 over a range of engine speeds. For example, in the embodiment shown, the compressor 16 has a maximum rated rotational speed of 9000 revolutions per minute. The TTD 14 is controlled by an electronic controller 42 (labelled CC in FIG. 1) to maintain the rotational speed of the driven element 28 at or below the predetermined maximum rated rotational speed by slipping the TTD 14. More specifically, the TTD 14 has an engaged state in which the drive element 26 and the driven element 28 rotate at a common speed (i.e., with no speed differential) so that any torque transfer from the drive element 26 to the driven element 28 is without slip. The TTD 14 also has a slipping state in which a speed differential exists between the drive element 26 and the driven element 28, so that any torque transfer from the drive element 26 to the driven element is with slip. The electronic controller 42 includes a processor 44 with a stored algorithm 46. The processor 44 executes the stored algorithm 46 to establish the slipping state to maintain a rotational speed of the rotatable component shaft 30 at or below the predetermined maximum rotational speed.

More specifically, in the embodiment of FIG. 1, the electronic controller 42 controls the TTD 14 to slip so that the drive element 26 rotates at a greater rotational speed than the driven element 28. The electronic controller 42 is operatively connected to the crankshaft 20, the rotatable component shaft 30, and the torque-transmission device 14 as indicated by dashed lines. The electronic controller 42 is operatively connected to the crankshaft 20 thorough a first speed sensor 50A at least a portion of which is mounted on the crankshaft 20. The electronic controller 42 is operatively connected to the rotatable component shaft 30 by a second speed sensor 50B at least a portion of which is mounted on the rotatable component shaft 30. The operative connections between the sensors 50A, 50B and the electronic controller 42 may be by transfer conductors, such as wires, or may be wireless. The speed sensors 50A, 50B can provide speed signals to the electronic controller 42 that are indicative of a rotational speed of the crankshaft 20 and of the rotatable component shaft 30, respectively. Based on these speed signals, the electronic controller 42 can determine the rotational speed of the rotatable component shaft 30, and control the TTD 14 to transition from the engaged state to the slipping state to prevent the rotatable component shaft 30 from rotating at a speed above the predetermined maximum rated rotational speed.

The electronic controller 42 may be part of a control system that also includes an engine controller 52 (labelled EC in FIG. 1), and a component controller, such as an air conditioning controller 54 (labelled A/C C in FIG. 1). The engine controller 52 can determine the rotational speed of the crankshaft 20 from various monitored engine operating parameters, as is understood by those skilled in the art. The engine controller 52 can therefore provide a signal to the electronic controller 42 indicative of the rotational speed of the crankshaft 20. The air conditioning controller 54 can provide a signal indicative of the rotational speed of the rotatable component 16 based on various monitored air conditioning compressor parameters. Accordingly, in one embodiment, neither sensor 50A nor sensor 50B need be provided. In other embodiments, only the speed sensor 50A or only the speed sensor 50B need be provided, as the electronic controller 42 can determine the rotational speed of the rotatable component shaft 30 from either of such speed sensors 50A, 50B when the TTD 14 is in the engaged state, and also from either of such speed sensors 50A, 50B and information provided from the engine controller 52 or the compressor controller 54 when the TTD 14 is in the slipping state. The slipping state is established by transitioning the TTD 14 from the engaged state when the electronic controller 42 determines that the rotational speed of the rotatable component shaft 30 would reach the maximum rated rotational speed.

The TTD 14 may be selectively engageable and disengageable so that it also has a disengaged state in which torque transfer from the drive element 26 to the driven element 28 is zero. The processor 44 of the electronic controller 42 executes the stored algorithm 46 to increase the torque provided by the engine 18 at the crankshaft 20 when controlling the TTD 14 to transition from the disengaged state to the engaged state. This enables the engine 18 to handle the increased load of the compressor 16 and of any other engine-driven components connected to the engine 18 via the TTD 14 without a drop in driveline torque at the vehicle drive axle or axles (not shown). In FIG. 1, the TTD 14 is shown in a disengaged state. In an engaged state, the drive element 26 and the driven element 28 are moved so that they are in operative contact with one another with sufficient force such that there is no slip (i.e., no speed differential between the drive element 26 and the driven element 28). In the slipping state, the drive element 26 and the driven element 28 are in operative contact with one another but without sufficient force to prevent slip, so that there is a speed differential between the drive element 26 and the driven element 28.

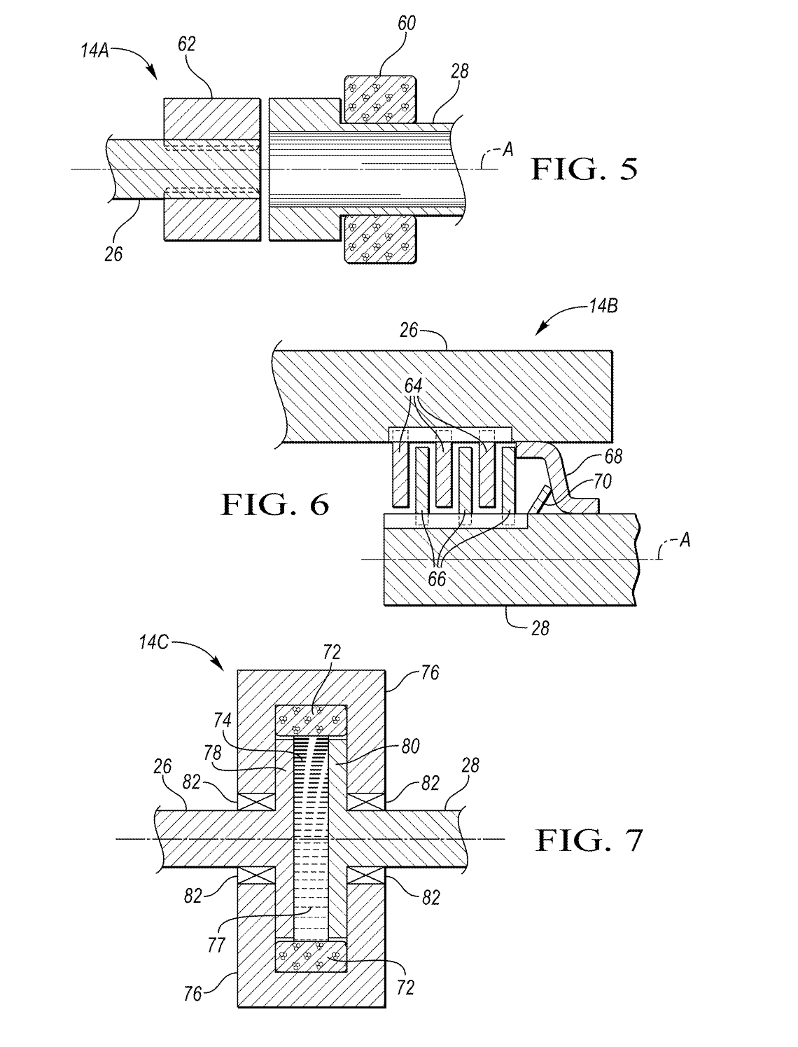

The TTD 14 may be any one of various types of torque-transmission devices that can have at least an engaged state and a slipping state, and optionally, a disengaged state. For example, FIG. 5 shows a TTD 14A that may be used as the TTD 14 of FIG. 1. The TTD 14A is an electromagnetic clutch. The TTD 14A includes a selectively energizable electrical coil 60 that can be energized to pull a magnetic member 62 splined to the drive element 26 into contact with the driven element 28. The energizing of the coil 60 is controlled to control the force at which the drive element 26 is pulled toward and contacts the driven element 28, thereby creating either the slipping state or the engaged state. The amount of slip and therefore the speed differential is controlled by controlling the energizing of the coil 60, ensuring that the rotational speed of the driven element 28 does not exceed the predetermined maximum rated rotational speed. The drive element 26 and the driven element 28 rotate about the axis of rotation A in FIG. 5.

FIG. 6 shows a TTD 14B that may be used as the TTD 14 of FIG. 1. The TTD 14B is a friction plate clutch. The TTD 14B includes a first set of friction plates 64 splined to and rotating with the drive element 26, and a second set of friction plate 66 splined to and rotating with the driven element 28. The friction plates 64 are interleaved with the friction plates 66. An apply piston 68 is biased away from the plates 64, 66 by a spring element 70, but may be moved axially toward the plates 64, 66 such as under hydraulic pressure to overcome the spring 70 and cause adjacent ones of the plates 64, 66 to move into contact with one another, as is understood by those skilled in the art. The hydraulic pressure may be controlled to provide sufficient force between the plates 64, 66 so that the TTD 14B establishes the engaged state. With less hydraulic pressure, the plates 64, 66 are only in slipping contact with one another so that the slipping state is established. The hydraulic pressure is controlled to control the amount of slip and therefore the speed differential between the drive element 26 and the driven element 28, ensuring that the rotational speed of the driven element 28 does not exceed the predetermined rotational speed. The drive element 26 concentrically surrounds the driven element 28 in the TTD 14B, and both rotate about the axis of rotation A. The plates 64, 66 are shown extending only between the drive element 26 and the driven element 28 on only one side of the axis A, but are annular plates. Those skilled in the art will readily understand that the plates 66 also extend downward from the drive element 28 in FIG. 6, and the plates 64 extend upward from the other portion of the drive element 26 concentrically surrounding the driven element 28 but not shown in FIG. 6.

FIG. 7 shows another alternative embodiment of a TTD 14C that may be used as the TTD 14 of FIG. 1. The TTD 14C is a magnetorheological clutch. A coil 72 surrounds magnetorheological fluid 77 contained in a cavity 74 of a housing 76. An end portion 78 of the drive element 26 and an end portion 80 of the driven element 28 are rotatably supported in the housing 76 by bearings 82 such that the end portions 78, 80 are in contact with the magnetorheological fluid 77. The coil 72 is selectively energizable to magnetize the magnetorheological fluid 77, increasing its viscosity and thereby permitting torque transmission from the drive element 26 to the driven element 28. In the engaged state, the coil 72 is energized sufficiently such that the drive element 16 rotates in unison with the driven element 28 about the axis of rotation A, i.e., without slip. In the slipping state, the energizing of the coil 60 is controlled so that the amount of slip (i.e., the speed differential) between the drive element 26 and the driven element 28 ensures that the rotational speed of the driven element 28 does not exceed the predetermined maximum rated rotational speed.

FIG. 2 shows another embodiment of a vehicle 110 that has a system 112 that controls the TTD 14 to slip to prevent the engine-driven component 16 from exceeding the predetermined maximum rated rotational speed. As in FIG. 1, the TTD 14 can be any of various embodiments of a controllable slipping torque-transmission device, such as described with respect to FIGS. 5-7. The system 112 is alike in all aspects and functionality as system 12 of FIG. 1 except that the drive element 26 is operatively connected to the crankshaft 20 via a gear train 83. The gear train 83 has a first gear member 84 connected to the crankshaft 20 so that the first gear member 84 rotates in unison with the crankshaft 20. The gear train 83 also includes a second gear member 85 that meshes with the first gear member 84 and is connected to the drive element 26 so that the second gear member 85 rotates in unison with the drive element 26.

The sensor 50A is mounted on the drive element 26 to rotate in unison with the drive element 26. Because the rotational speed of the drive element 26 is directly proportional to the rotational speed of the crankshaft 20 in accordance with the gear ratio of the number of teeth of the first gear member 84 to the number of teeth of the second gear member 85, the speed signal provided to the electronic controller 42 by the speed sensor 50A is indicative of the rotational speed of the crankshaft 20.

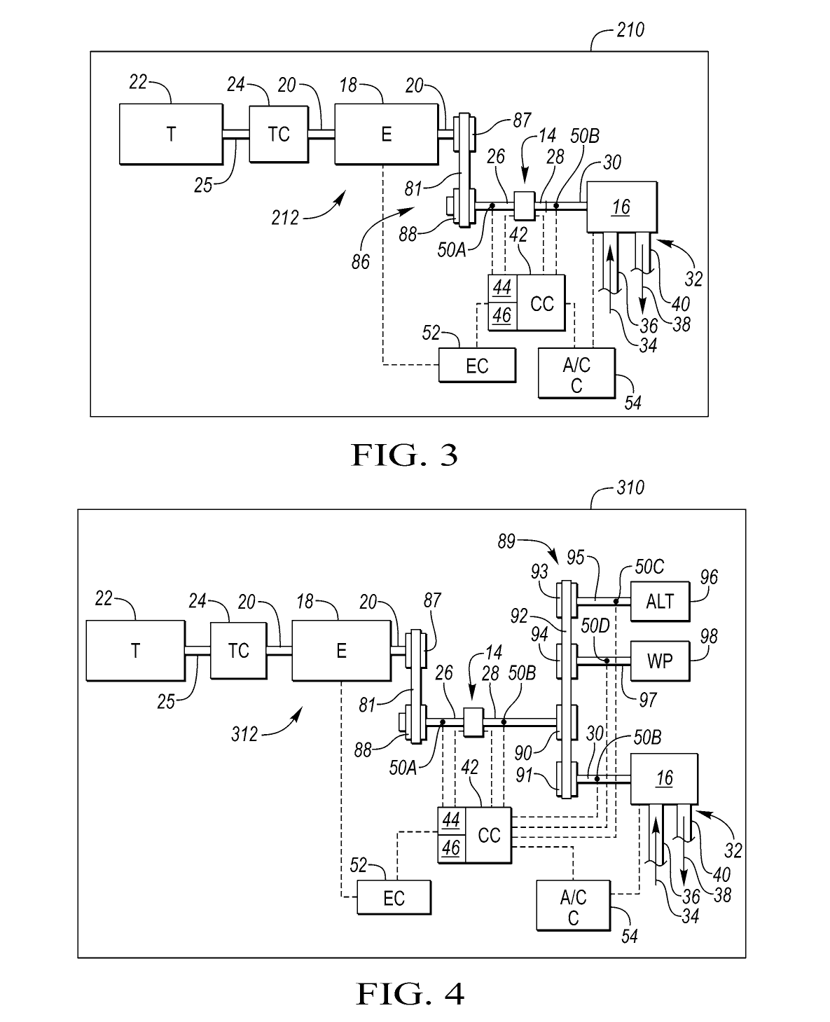

FIG. 3 shows another embodiment of a vehicle 210 that has a system 212 that controls the torque-transmission device (TTD) 14 to slip to prevent the engine-driven component 16 from exceeding the predetermined maximum rated rotational speed. The system 212 is alike in all aspects and functionality as system 12 except that the drive element 26 is operatively connected to the crankshaft 20 via a first drive train 86. The first drive train 86 has a first rotatable member 87 connected to the crankshaft 20 so that the first rotatable member 87 rotates in unison with the crankshaft 20. The first drive train 86 has a second rotatable member 88 connected to the drive element 26 so that the second rotatable member 88 rotates in unison with the drive element 26. A first endless rotatable device 81 is engaged with the first rotatable member 87 and with the second rotatable member 88. The first rotatable member 87 and the second rotatable member 88 may be pulleys, and the first endless rotatable device 81 may be a belt that engages the pulleys. Alternatively, the first rotatable member 87 and the second rotatable member 88 may be sprockets, and the first endless rotatable device 81 may be a chain that engages the sprockets.

The sensor 50A is mounted on the drive element 26 to rotate in unison with the drive element 26. Because the rotational speed of the drive element 26 is directly proportional to the rotational speed of the crankshaft 20 in accordance with the ratio of the diameter of the first rotatable member 87 to the diameter of the second rotatable member 88, the speed signal provided to the electronic controller 42 by the speed sensor 50A is indicative of rotational speed of the crankshaft 20.

FIG. 4 shows another embodiment of a vehicle 310 that has a system 312 that controls the TTD 14 to slip to prevent the engine-driven component 16 from exceeding the predetermined maximum rated rotational speed. As in FIG. 1, the TTD 14 can be any of various embodiments of a controllable slipping torque-transmission device, such as described with respect to FIGS. 5-7. The system 312 is alike in all aspects and functionality as system 212 of FIG. 2 except that the driven element 28 is operatively connected to the rotatable component shaft 30 via a second drive train 89.

The second drive train 89 has a third rotatable member 90 connected to the driven element 28 so that the third rotatable member 90 rotates in unison with the driven element 28. A fourth rotatable member 91 is connected to the rotatable component shaft 30 so that the fourth rotatable member 91 rotates in unison with the rotatable component shaft 30. A second endless rotatable device 92 is engaged with the third rotatable member 90 and with the fourth rotatable member 91. Optionally, the second drive train 89 may also include a fifth rotatable member 93 and a sixth rotatable member 94 also engaged with the second endless rotatable device 92. The fifth rotatable member 93 is connected to a first accessory shaft 95 of a first vehicle accessory component 96 to rotate in unison therewith, and the sixth rotatable member 94 is connected to a second accessory shaft 97 of a second vehicle accessory component 98 to rotate in unison therewith. In the embodiment shown, the first vehicle accessory component 96 is an alternator (labelled ALT), and the second vehicle accessory component 98 is a water pump 98 (labelled WP). Accordingly, the first and second vehicle accessory components 96, 98 are also driven by the engine via the TTD 14 and the first and second drive trains 86, 89.

The third, fourth, fifth, and sixth rotatable members 90, 91, 93, 94 may be pulleys, and the second endless rotatable device 92 may be a belt that engages the pulleys. Alternatively, the third, fourth, fifth, and sixth rotatable members 90, 91, 93, 94 may be sprockets, and the second endless rotatable device may be a chain that engages the sprockets.

The second speed sensor 50B is mounted on the driven element 28 to rotate in unison with the driven element 28. Because the rotational speed of the driven element 28 is directly proportional to the rotational speed of the rotatable component shaft 30 in accordance with the ratio of the diameter of the third rotatable member 90 to the diameter of the fourth rotatable member 91, the speed signal provided to the electronic controller 42 by the speed sensor 50B is indicative of rotational speed of the rotatable component shaft 30. Additionally, because the rotational speed of the driven element 28 is directly proportional to the rotational speed of the first accessory shaft 95 in accordance with the ratio of the diameter of the third rotatable member 90 to the diameter of the fifth rotatable member 93, the speed signal provided to the electronic controller 42 by the speed sensor 50B is indicative of rotational speed of the first accessory component shaft 95. Likewise, because the rotational speed of the driven element 28 is directly proportional to the rotational speed of the second accessory shaft 97 in accordance with the ratio of the diameter of the third rotatable member 90 to the diameter of the sixth rotatable member 94, the speed signal provided to the electronic controller 42 by the speed sensor 50B is indicative of rotational speed of the second accessory component shaft 97. Alternatively or in addition, the system 312 may include a third speed sensor 50C at least a portion of which is mounted on the first accessory shaft 95, and a fourth speed sensor 50D at least a portion of which is mounted on the second accessory shaft 97.

The operative connections between the sensors 50C, 50D and the electronic controller 42 may be by transfer conductors, such as wires, or may be wireless. The speed sensors 50C, 50D can provide a speed signal to the electronic controller 42 that is indicative of a speed of the first accessory shaft 95 and of the second accessory shaft 97, respectively. The processor 44 may further execute the stored algorithm 46 to establish the slipping state of the TTD 14 to maintain a rotational speed of the first accessory shaft 95 and/or a rotational speed of the second accessory shaft 97 below a second predetermined maximum rated rotational speed.

While the best modes for carrying out the many aspects of the present teachings have been described in detail, those familiar with the art to which these teachings relate will recognize various alternative aspects for practicing the present teachings that are within the scope of the appended claims.

1. A system on a vehicle comprising:
an engine having a rotatable crankshaft;
an engine-driven component having a rotatable component shaft;
a torque-transmission device having a drive element operatively connected to the crankshaft and a driven element operatively connected to the rotatable component shaft; wherein the torque-transmission device has a slipping state in which slip occurs during torque transfer from the drive element to the driven element so that a speed differential exists between the drive element and the driven element;
an electronic controller operatively connected to the crankshaft, the rotatable component shaft, and the torque-transmission device; wherein the electronic controller includes a processor with a stored algorithm; and wherein the processor executes the stored algorithm to establish the slipping state to maintain a rotational speed of the rotatable component shaft at or below a predetermined rotational speed.

2. The system of claim 1, further comprising:
a speed sensor operatively connected to the electronic controller and to one of the crankshaft and the rotatable component shaft and configured to provide a speed signal indicative of the rotational speed of said one of the crankshaft and the rotatable component shaft; and
wherein the electronic controller determines the rotational speed of the rotatable component shaft based on the speed signal.

3. The system of claim 1, further comprising:
an engine controller operatively connected to the engine and to the electronic controller and configured to provide a first signal indicative of the rotational speed of the crankshaft;
a component controller operatively connected to the engine-driven component and to the electronic controller and configured to provide a second signal indicative of the rotational speed of the rotatable component shaft; and
wherein the electronic controller determines the rotational speed of the rotatable component shaft based on either or both of the first signal and the second signal.

4. The system of claim 1, wherein the drive element rotates in unison with the crankshaft and the driven element rotates in unison with the rotatable component shaft.

5. The system of claim 1, further comprising:
a gear train having:
a first gear member connected to the crankshaft so that the first gear member rotates in unison with the crankshaft; and
a second gear member meshing with the first gear member and connected to the drive element so that the second gear member rotates in unison with the drive element.

6. The system of claim 1, further comprising:
a first drive train having:
a first rotatable member connected to the crankshaft so that the first rotatable member rotates in unison with the crankshaft;
a second rotatable member connected to the drive element so that the second rotatable member rotates in unison with the drive element; and
a first endless rotatable device engaged with the first rotatable member and with the second rotatable member.

7. The system of claim 6, further comprising:
a second drive train having:
a third rotatable member connected to the driven element so that the third rotatable member rotates in unison with the driven element;
a fourth rotatable member connected to the rotatable component shaft so that the fourth rotatable member rotates in unison with the rotatable component shaft; and
a second endless rotatable device engaged with the third rotatable member and with the fourth rotatable member.

8. The system of claim 7, wherein the predetermined rotational speed is a first predetermined rotational speed, and further comprising:
a vehicle accessory component having a rotatable accessory shaft;
wherein the second drive train further includes:
a fifth rotatable member connected to the accessory shaft so that the fifth rotatable member rotates in unison with the accessory shaft;
wherein the second endless rotatable device is engaged with the fifth rotatable member; and
wherein the processor further executes the stored algorithm to establish the slipping state to maintain a rotational speed of the accessory shaft at or below a second predetermined rotational speed.

9. The system of claim 1, wherein the torque-transmission device is an electromagnetic clutch.

10. The system of claim 1, wherein the torque-transmission device is a friction plate clutch.

11. The system of claim 1, wherein the torque-transmission device is a magnetorheological clutch.

12. The system of claim 1, wherein the torque-transmission device has a disengaged state in which torque transfer from the drive element to the driven element is zero; wherein the torque-transmission device has an engaged state in which the drive element and the driven element rotate at a common speed; and wherein the electronic controller executes the stored algorithm to increase the torque provided by the engine at the crankshaft when controlling the torque-transmission device to transition from the disengaged state to the engaged state.

13. The system of claim 1, wherein the engine-driven component is an air conditioning compressor; and wherein the predetermined rotational speed is 9000 revolutions per minute.

14. A system on a vehicle comprising:
an engine having a rotatable crankshaft;
an air conditioning compressor for a climate control system; wherein the air conditioning compressor includes a rotatable compressor shaft;
a torque-transmission device having a drive element operatively connected to the crankshaft and a driven element operatively connected to the compressor shaft; wherein the torque-transmission device has an engaged state in which the drive element and the driven element rotate at a common rotational speed, and a slipping state in which slip occurs during torque transfer from the drive element to the driven element so that the drive element rotates at a rotational speed greater than a rotational speed of the driven element;
an electronic controller operatively connected to the crankshaft, the compressor shaft, and the torque-transmission device; wherein the electronic controller includes a processor with a stored algorithm; and wherein the electronic controller executes the stored algorithm to establish the slipping state to maintain the rotational speed of the compressor shaft at or below 9000 revolutions per minute.

15. The system of claim 14, further comprising:
a speed sensor operatively connected to the electronic controller and to one of the crankshaft and the compressor shaft and configured to provide a speed signal indicative of the rotational speed of said one of the crankshaft and the compressor shaft; and
wherein the electronic controller determines the rotational speed of the compressor shaft based on the speed signal.

16. The system of claim 14, further comprising:
an engine controller operatively connected to the engine and to the electronic controller and configured to provide a first signal indicative of the rotational speed of the crankshaft;
a heating-ventilation-air conditioning (HVAC) controller operatively connected to the compressor and to the electronic controller and configured to provide a second signal indicative of the rotational speed of the compressor shaft; and
wherein the electronic controller determines the rotational speed of the compressor shaft based on either or both of the first signal and the second signal.

17. A vehicle comprising:
an engine having a rotatable crankshaft;
a first engine-driven component having a rotatable component shaft;
an engine-driven vehicle accessory component having a rotatable accessory shaft;
a drive train having:
a first rotatable member connected with the first engine-driven component so that the first rotatable member rotates in unison with the rotatable component shaft;
an additional rotatable member connected with the vehicle accessory component so that the additional rotatable member rotates in unison with the accessory shaft; and
an endless rotatable device engaged with the first rotatable member and the additional rotatable member;
a selectively engageable torque-transmission device having a drive element operatively connected to the crankshaft and a driven element operatively connected to the rotatable component shaft and to the accessory shaft via the drive train; wherein the torque-transmission device has an engaged state in which the drive element and the driven element rotate at a common rotational speed, and a slipping state in which slip occurs during torque transfer from the drive element to the driven element so that the drive element rotates at a rotational speed greater than a rotational speed of the driven element;
an electronic controller operatively connected to the crankshaft, the rotatable component shaft, and the torque-transmission device; wherein the electronic controller includes a processor with a stored algorithm; wherein the processor executes the stored algorithm to establish the slipping state to maintain a rotational speed of the rotatable component shaft at or below a first predetermined rotational speed and to maintain a rotational speed of the accessory shaft at or below a second predetermined rotational speed.

18. The vehicle of claim 17, further comprising:
a speed sensor operatively connected to the electronic controller and to at least one of the crankshaft, the rotatable component shaft, and the accessory shaft, and configured to provide a speed signal indicative of the rotational speed of said at least one of the crankshaft, the rotatable component shaft, and the accessory shaft; and
wherein the electronic controller determines the rotational speed of the rotatable component shaft based on the speed signal.

19. The vehicle of claim 17, further comprising:
an engine controller operatively connected to the engine and to the electronic controller and configured to provide a first signal indicative of the rotational speed of the crankshaft;
a component controller operatively connected to the engine-driven component, the vehicle accessory component, and to the electronic controller and configured to provide a second signal indicative of the rotational speed of the rotatable component shaft, and the rotational speed of the accessory shaft; and
wherein the electronic controller determines a speed differential between the drive element and the driven element based on the first signal and the second signal.
